(19) United States
(12) Patent Application Publication
(10) Pub. No.: US 2007/0133448 A1
(43) Pub. Date: Jun. 14, 2007

(54) METHOD AND APPARATUS FOR OPTIMAL ATIM SIZE SETUP FOR 802.11 NETWORKS IN AN AD HOC MODE

(76) Inventors: Xia Gao, Cupertino, CA (US); Moo Ryong Jeong, Saratoga, CA (US); Fujio Watanabe, Union City, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/564,138

(22) Filed: Nov. 28, 2006

Related U.S. Application Data
(60) Provisional application No. 60/749,141, filed on Dec. 9, 2005.

(51) Int. Cl. G08C 17/00

(52) U.S. Cl. 370/311

(57) ABSTRACT

A method for power saving in an ad hoc wireless computer network determines an optimal ATIM message exchange window. The method (a) determines an effective number of nodes that participate in exchanges of ATIM messages during an ATIM window; (b) using the effective number of nodes, calculating a length for a data frame transmission window; and (c) calculates a length for the ATIM window using the calculated data frame transmission window. In one instance, the method determines the effective number of nodes based on the number of senders of ATIM messages. In another instance, the effective number of nodes is determined based on both senders and recipients of the ATIM messages. The method may determine the effective number of nodes from a number of successful ATIM message transmissions in a given time period. The calculated ATIM window size can be provided as an initial value to other methods that dynamically adjust the ATIM window size.

### CROSS-REFERENCE TO RELATED APPLICATIONS

The present application is related to, and claims priority to, U.S. provisional patent application, entitled “Methods and Apparatus for Optimal ATM Size Setup for 802.11 Networks in Ad Hoc Mode,” Ser. No. 60/749,141, filed on Dec. 9, 2005. This provisional patent application is hereby incorporated by reference in its entirety.

### BACKGROUND OF THE INVENTION

1. Field of the Invention

The present invention relates to wireless computer networks. In particular, the present invention relates to operations in an ad hoc wireless computer network.

2. Discussion of the Related Art

A wireless computer network provides continuous network access to mobile users as they move about. To provide this mobility, mobile devices rely on batteries for power. Battery power is a scarce resource, and battery lifetime improvements have been lagging relative to improvements in computing power and communication capabilities of the mobile devices. Hence, energy efficiency is an important metric in network design.

As compared to power management in an infrastructure network, power management in the link layer of an ad hoc wireless network (e.g., an ad hoc wireless network using the independent basic service set or “IBSS” under 802.11b) is not well understood and is not efficient. For example, in a wireless local area network (WLAN), the access point (“AP”) has global knowledge of the power-saving states of all stations (“STAs”) associated with it. In such a network, all communication with the mobile nodes go through the AP, so that the AP may buffer data packets designating STAs in a power-saving (“PS”) mode. During pre-specified time intervals, the AP notifies these STAs to retrieve the buffered packets. In contrast, however, in an ad hoc wireless network, there is no entity in IBSS similar to AP that has global knowledge of power-saving states of all nodes. Instead, each STA stores packets locally and communicates individually with its peers to schedule packet delivery.

Due to the distributed nature of IBSS, many power-saving issues exist in IBSS under 802.11.

In WLANs operating under 802.11, the distributed coordination function (“DCF”) uses a Carrier Sense Multiple Access with Collision Avoidance (CSMA/CA) protocol to determine—in a distributed manner—when a station operating within the wireless network is permitted to transmit and receive frames. Under CSMA/CA, prior to transmission, an STA senses the medium to determine if it is “busy” (i.e., if another STA is transmitting). If the medium is not busy, the STA may transmit. CSMA/CA requires a minimum specified separation in time, called the “interframe space” (IFS), between contiguous frame sequences. The transmitter waits the medium to become idle for at least IFS before transmitting. The value of IFS varies according to the priority of the transmitted frames. Examples of IFS values include: short IFS (SIFS), point IFS (PIFS), distributed IFS (DIFS) and extended IFS (EIFS).

SIFS is the shortest interframe space and is used when a group of STAs have seized the medium for the duration of the frame exchange sequence to be performed. SIFS ensures completion of the frame exchange sequence before other STAs can access the medium, as the other STAs are required to wait for the medium to become idle for a time period longer than SIFS before attempting to transmit into the medium. Acknowledgment (ACK) frames, for example, use SIFS.

PIFS is used by STAs operating under the point coordination function (PCF) to gain priority access to the medium at the start of a contention-free period. PIFS is longer than SIFS, but shorter than DIFS.

DIFS is used by stations operating under the DCF to transmit data frames and management frames (e.g., probe request and probe responses).

EIFS (extended IFS) is used by the DCF whenever the physical layer (PHY) indicates to the media access control (MAC) layer that a frame transmission began, but a complete MAC frame with a correct frame check sequence (FCS) value has not been received. The EIFS interval begins after the PHY indicates that the medium is idle following detecting an erroneous frame, without regard to the virtual carrier-sense mechanism.

Under DCF, if the medium is found busy, a STA defers transmission until after the current transmission completes. After a deferral, or prior to attempting to transmit again immediately after a successful transmission, a station selects a random “back-off” interval during which it does not transmit. A back-off interval counter keeps track of the interval.

Some example formats of control packets are provided in FIGS. 1 (“data frame”) and 3 (“acknowledge (ACK) frame”). A control packet has a format (i.e., “management frame”) generically shown in FIG. 4. As shown in FIG. 4, the format includes a medium access control (MAC) header, a frame body and a frame check sequence (FCS). The FCS allows a determination on the integrity of a transmitted frame. In a 802.11 WLAN, a STA uses the destination address (DA) field in the MAC header of a packet to make receive decisions regarding the packet. For example, the DA field may contain a group address (e.g., a broadcast address) and, if the frame is not a beacon frame, the basic service set identifier (BSSID) must be validated (i.e., the BSSID field of the frame is the same BSSID of the recipient). (The BSSID field can be a broadcast BSSID in a probe request frame.) As another example, a STA, including an AP, may respond with an ACK frame within an SIFS deferral upon receiving a data frame or a management frame that does not specify a group address in the DA field. An ACK frame is not be transmitted for a packet specifying a group address in the DA field.

The state of the medium is determined from the physical and virtual carrier-sense functions. The physical layer provides a physical carrier-sense mechanism based on energy detection in the wireless medium. The MAC layer provides a virtual carrier-sense mechanism, referred to as the network allocation vector (NAV). The NAV predicts future traffic in the medium based on duration information that is announced in the frames prior to the actual exchange of data. With a few exceptions, such duration information is found in the MAC header.

Four types of frames under IEEE 802.11 are relevant to the present invention. A “data frame” carries higher-level protocol data in the frame body. FIG. 1 shows the fields of a generic data frame. Depending on the particular type of data frame, some of the fields in the FIG. 1 may not be present. FIG. 2 shows the frame control field within a data frame. As shown in FIG. 2, the field control field includes type bits (B₂, B₃) and subtype bits (B₄-B₇) that together identify a frame type. The various values for type and subtype bits in a data frame are provided in Table 1 below.

An “ACK” frame sends a positive acknowledgement in response to a received frame. FIG. 3 shows the fields of an “ACK” frame.

An “announcement traffic indication message (ATIM)” frame is a management frame sent during the ATIM period. FIG. 4 shows the fields of a management frame. In an ad hoc wireless network under IBSS, no data buffering service at an AP is offered. When an STA in an IBSS network has a buffered frame for a receiver in low-power mode, the STA sends an ATIM frame during the ATIM period to notify the recipient of the buffered data. The frame body of an ATIM frame is null.

A “beacon” frame, which is another management frame, announces the existence and the identity of a network, and plays an important part in many network maintenance tasks. Beacon frames are transmitted at regular intervals to announce the network to mobile STAs, as well as match parameters for joining the network. A beacon frame includes a timestamp field, a beacon interval field, a capability field, a service set identifier (SSID) field, an IBSS parameter set field, and a traffic indication map (TIM) field. The IBSS parameter set field specifies a set of parameters necessary to support an IBSS network. FIG. 5 shows the fields of the IBSS parameter set field.

TABLE 1
Example of valid type and subtype combinations

| | | Subtype | |
|---|---|---|---|
| Type Value | Type | value | |
| B3 B2 | description | B7 B6 B5 B4 | Subtype description |
| 00 | Management | 1000 | Beacon |
| 00 | Management | 1001 | ATIM |
| 00 | Management | 1101 | Action |
| 00 | Management | 1110-1111 | Reserved |
| 10 | Data | 0000 | Data |
| 01 | Control | 1101 | Acknowledgement (ACK) |

In an infrastructure network, APs are responsible for transmitting beacon frames. The service area of an AP is defined by the reach of its beacon frames. Timing for the BSS is determined by the beacon interval specified in a beacon frame. The time interval between successive transmissions of beacon frames is called the “target beacon transition time” or TBTT.

In an IBSS network, beacon frames are generated in a distributed manner. The beacon interval is included in both beacon frames and probe response frames. The STAs adopt the beacon interval at the time each STA join the ad hoc network. In an IBSS network, all members participate in beacon generation. Each STA maintains a timing synchronization function (TSF) timer for beacon interval timing. As an IBSS network does not have access points, when a STA has buffered frames for a recipient that is in a low-power mode, the STA sends an announcement traffic indication message (ATIM) frame during the ATIM window to notify the recipient that it has buffered data for the recipient. The ATIM frame has a null frame body.

FIG. 6 shows the process of beacon frame generation in an IBSS. At each TBTT, each station (a) waits for the packet currently transmitting in the channel to complete, (b) suspends the back-off timer for any pending non-beacon or non-ATIM transmission, and (c) calculates a random delay that is uniformly distributed in the range between zero and 2*CWₘᵢₙ*TU, where CWₘᵢₙ is the size of the minimum contention window and TU is the timing unit. The STA then sets a timer using this random delay and wait for this timer to expire. If a beacon frame arrives before the random delay timer expires, the wait is canceled, and the backoff timer is resumed. However, if the random delay timer expires without the STA receiving a beacon frame, the STA sends out a beacon frame. ATIM messages are transmitted following the beacon frame from source stations to destination stations using the same distributed coordination function (DCF) algorithm as ordinary data packets. The length of the ATIM window is fixed and always starts from the theoretical TBTT time, whether or not there is packet transmission during the beacon interval.

The timestamp field in the beacon frame represents the value in the TSF timer at the frame's source. A station joining an IBSS network initializes its TSF timer to 0 and refrains from transmitting a beacon frame or a probe response frame until after it receives a beacon frame or a probe response frame from another member of the IBSS with a matching SSID to ensure proper synchronization within the IBSS network.

In an IBSS network, a STA may be in an “awake” state, in which the STA is fully powered, or in a “doze” state, in which the STA consumes little power and is unable to transmit or receive. The term “power management” for an STA refers to the manner in which an STA transits between awake and doze states.

In an infrastructure network, an STA changing its power management mode to a doze or PS state informs the AP using the power management bits within the frame control field of the transmitted frames. Thereafter, the AP does not arbitrarily transmit MAC service data units (MSDUs) to the STA. The MSDUs are buffered and transmitted at designated times. The STAs associated with an AP that has buffered MSDUs for the STAs are identified in a TIM that is included in all beacon frames generated by the AP. By interpreting the TIM, an STA is made aware that an MSDU is buffered for it. An STA operating in PS modes periodically listens for beacon frames, according to its listen interval and receive delivery traffic indication message (DTIM) parameters. Upon learning that an MSDU is currently buffered in the AP, the STA transmits a short PS-poll frame to the AP, which responds with the corresponding buffered MSDU immediately, or acknowledges the PS-Poll and responds with the corresponding MSDU at a later time. If a STA in its BSS is in PS mode, the AP buffers all broadcast and multicast MSDUs and delivers them to the STA immediately following the next beacon frame containing a DTIM transmission.

FIG. 7 shows the basic operations of power management in an IBSS. As shown in FIG. 7, after each TBTT, an ATIM window is defined. During the ATIM window, STAs operating in PS mode are awake to listen to beacon frames or ATIM frames. To transmit an MSDU to a recipient STA in a PS mode, the transmitting STA first transmits an ATIM frame during the ATIM window. ATIM transmissions from different STAs are randomized using the common DCF backoff procedure. Directed ATIMs are acknowledged. If an ACK frame is not received in response to a directed ATIM, the transmitting STA executes the back-off procedure to attempt a retransmission. Multicast ATIMs are not acknowledged. After the ATIM interval, the acknowledged MSDUs and the announced broadcast/multicast MSDUs are transmitted to STAs in the PS mode, using normal DCF access procedures. If an STA is unable to transmit a buffered MSDU during the beacon interval in which the MSDU is announced, the STA retains the buffered MSDU and announces it again in an ATIM during the next ATIM window. After all buffered MSDUs are transmitted, MSDUs are transmitted unannounced to STAs that are in the awake state.

A STA operating in PS mode enters the awake state prior to each TBTT. If the STA receives an ATIM management frame directed to it, or a multicast ATIM management frame during the ATIM Window, the STA remains in the awake state until the end of the next ATIM window. An STA that has transmitted a beacon frame or an ATIM management frame will remain in the awake state until the end of the next ATIM window, regardless of whether or not an acknowledgement is received for the ATIM. If the STA has not transmitted an ATIM and does not receive either an ATIM management frame directed to it, or a multicast ATIM management frame during the ATIM window, the STA may return to the Doze state following the end of the current ATIM window.

The ATIM window size has implications to power management and performance. A large ATIM window is not desirable because every STA needs to stay awake for the duration of the ATIM window, so that a large ATIM window results in unnecessary power consumption to those STAs without incoming and outgoing traffic. The data transmission period following the ATIM period within the same beacon interval may also become too small, such that not all STAs with successful ATIM/ACK message exchange in the ATIM window may be able to transmit data in the data transmission period. Thus, the short data frame transmission not only increases transmission delay, but also wastes the energy of those STAs with unfinished data transmissions, which must stay awake over the duration of the entire beacon period.

Conversely, too short an ATIM window is also undesirable. If the ATIM window size is too small, a STA may not be able to send out all its ATIM messages to its peers within the ATIM window. Such a STA has to wait for the next beacon interval, resulting in a delay in transmission. The data transmission period will become too long relative to the number of packets to be transmitted as determined during the ATIM window. Some bandwidth will therefore be wasted.

PCT Patent Application Publication WO 2004/077762 A1, entitled “Power management in an IEEE 802.11 IBSS WLAN using an adaptive ATIM window,” by Z. Zhong, filed September 2004, proposes a scheme which dynamically adjusts the size of an ATIM window. Under this scheme, each STA uses the gap between the last overheard ATIM frame transmission and the end of the ATIM window to determine whether or not to increase or decrease the size of its ATIM window. Each STA competes to send its beacon containing its proposed ATIM window size. The winner's proposed window size is then adopted by all STAs of the IBSS. More specifically, each station keeps pre-determined values MAX_GAP, DA_MIN, and DA_DECR, where MAX_GAP is the maximal unused ATIM window size, DA_MIN is the smallest ATIM window size allowed, and DA_DECR is a pre-set amount to decrement the size of ATIM window. The algorithm to decrease ATIM window size is:

If GAP ≧ MAX _{—} GAP then ATIM_Size =
max [DA_MIN, ATIM_Size − DA_DECR].

Similarly, each station keeps a pre-determined MAX_NO_DA, DA_MAX, and DA_INCR, where MAX_NO_DA is the longest untransmitted ATIM message, DA_MAX is the largest ATIM window size, and DA_INCR is a preset amount to increase the size of ATIM window. The algorithm to increase ATIM window size is then:

If Untransmitted _{—} data ≧ MAX _{—} NO _{—} DA then ATIM_Size =
min [DA_MAX, ATIM_Size + DA_INCR].

As discussed above, existing work does not provide a mechanism to set up an initial ATIM window size, but relies completely on dynamic adaptation schemes to adjust ATIM window sizes. Dynamic adaptation schemes not only are time consuming, but are also unstable in some cases when the traffic variation changes dramatically.

It is therefore desirable to calculate an optimal ATIM window size based only on the number of nodes in the IBSS. Such a scheme determines an optimal initial ATIM window as nodes join or leave the system. Such a scheme may be combined with other dynamic adaptation schemes to achieve better performance.

### SUMMARY OF THE INVENTION

According to one embodiment of the present invention, a method calculates an optimal ATIM window size in an IBSS WLAN, based on the number of mobile stations in the network. The method is compatible with power saving techniques used in current 802.11 standards, and provides the lengths of different time periods including beacon transmission, ATIM transmission, and data transmission. Working together with other dynamic adaptation schemes, a method of the present invention can achieve good performance and reduced power consumption.

According to one embodiment, a method for power saving in an ad hoc wireless computer network determines an optimal ATIM message exchange window. The method (a) determines an effective number of nodes that participate in exchanges of ATIM messages during an ATIM window; (b) using the effective number of nodes, calculating a length for a data frame transmission window; and (c) calculates a length for the ATIM window using the calculated data frame transmission window. In one instance, the method determines the effective number of nodes based on the number of senders of ATIM messages. In another instance, the effective number of nodes is determined based on both senders and recipients of the ATIM messages. The method may determine the effective number of nodes from a number of successful ATIM message transmissions in a given time period. The calculated ATIM window size can be provided as an initial value to other methods that dynamically adjust the ATIM window size.

The present invention is better understood upon consideration of the detailed description and the accompanying drawings.

### BRIEF DESCRIPTION OF THE DRAWINGS

FIG. 1 shows the fields of a generic data frame.

FIG. 2 shows the fields within a frame control field of a data frame.

FIG. 3 shows the fields of an ACK frame.

FIG. 4 shows the fields of a management frame, such as an ATIM frame.

FIG. 6 shows the process of beacon frame generation in an IBSS.

FIG. 7 shows the basic operations of power management in an IBSS.

FIG. 8 shows a beacon interval made up by an ATIM/ACK exchange interval and a data transmission interval.

FIG. 9 shows the sequences of events that occur when a collision occurs when a transmission of an ATIM frame is attempted, and when a successful exchange of ATIM/ACK messages.

FIG. 10 is a block diagram of an overall system architecture under which a node of the present invention may improve an ATIM window size.

FIG. 11 shows a general procedure to calculate an optimal ATIM window size A_{ATIM}, in accordance with one embodiment of the present invention.

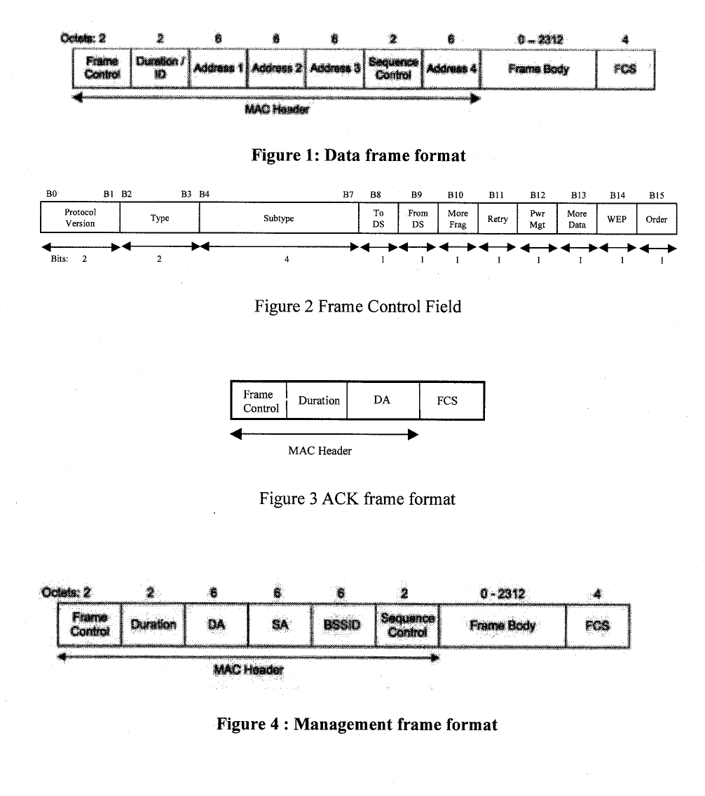

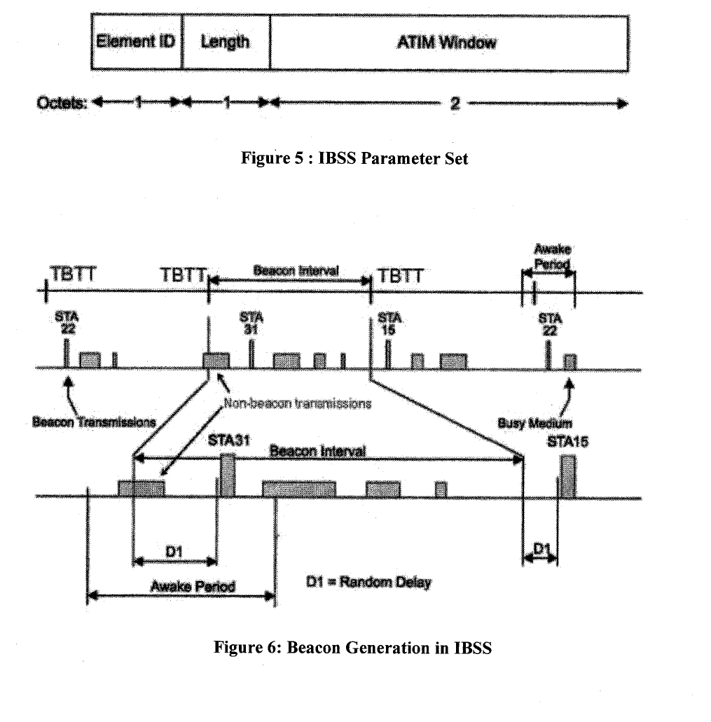

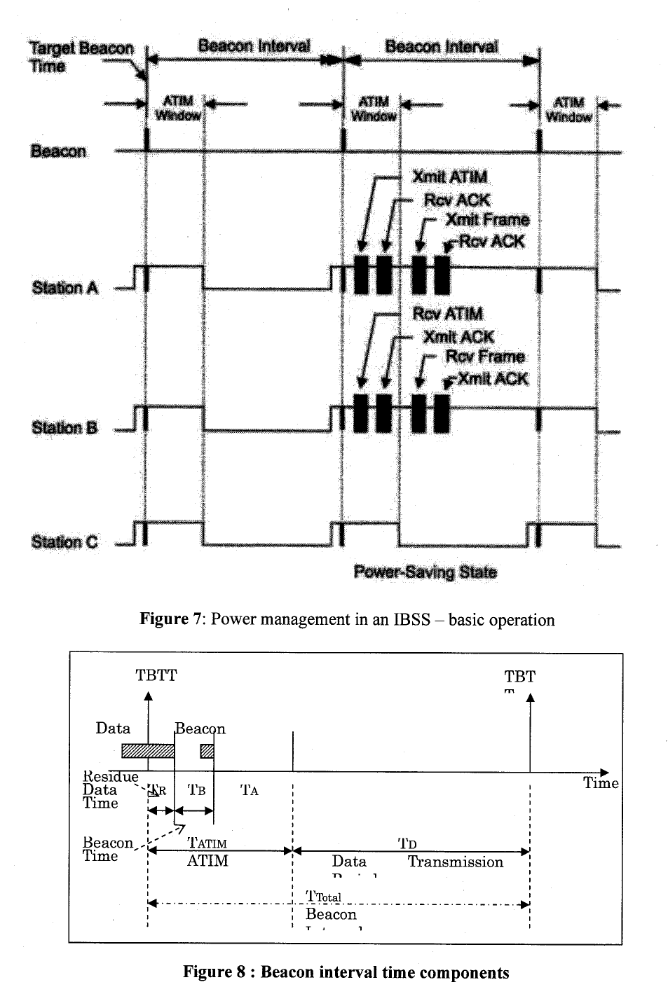

### DETAILED DESCRIPTION OF THE PREFERRED EMBODIMENTS

According to one embodiment of the present invention, an algorithm optimizes the ATIM window size for a give IBSS network based on a number of STAs in the network. In this embodiment, (a) STAs sending out or receiving ATIM messages within the ATIM window remain in the “awake” state until the end of the next ATIM window, as required by the 802.11 standards; (b) all STAs operate in a power saving mode (i.e., there are no always-on stations); (c) all nodes in the IBSS network can hear each other and, as a result, form a clique; (d) all STAs have equal priority; and (e) only STAs that have a successful ATIM/ACK message exchange during the ATIM window may transmit during the data transmission window. FIG. 8 shows a beacon interval made up of an ATIM/ACK window (T_{ATIM}) and a data transmission window (T_{D}). In STAs nodes that have no direct ATIM/ACK exchange may, however, infer each other's power saving state.

In one embodiment, the time interval between two adjacent transmission attempts is assumed exponentially distributed. In such a model, the channel attempt rate λ is given by a Poisson distribution and the channel collision rate p is constant, relating only to the current competing traffic load. For a network with N nodes within each other's transmission range, the current average channel attempt rate λ is given by

$$λ = {\sum }_{i = 1}^{N} \frac{1}{{L}_{i}} = \frac{N}{L} ,$$

where Lᵢ is the contention window for node i, and L is the average contention window size. The average arrival time of an attempted transmission is 1/λ.

The probability mass function in a time slot of k transmissions is then give by:

$$Pr [ k ] = \frac{{λ}^{k}}{k !} {ⅇ}^{- λ} .$$

Therefore, the channel collision rate p is given by
p=Pr[k≧2]=1−Pr[0]−Pr[1]=1−e^{-λ}−λe^{-λ}.

Let m be the number of retransmissions that reaches the maximum back-off window size (e.g., for an exponential back-off scheme, m is the value that satisfies 2^{m}*CWₘᵢₙ≧CWₘₐₓ). For an exponential back-off scheme, the probability that the jth collision window size occurs is given by:

$${c}_{j} = \{ \begin{matrix}{c}_{0} {p}^{j} , 1 \leq j \leq m - 1 , \\ {c}_{0} {\sum }_{j = m}^{∞} {p}^{j} = \frac{{c}_{0} {p}^{m}}{1 - p} , j = m\end{matrix}$$

As

$${\sum }_{j = 0}^{∞} {c}_{j} = 1 , {c}_{0} \cdot ( 1 + p + {p}^{2} + … + {p}^{m - 1} + \frac{{p}^{m}}{1 - p} ) = 1 ⇒ {c}_{0} = 1 - p .$$

If bⱼ is the jth contention window size, the average contention window size L is given by:

$$\begin{matrix}L = {\sum }_{j = 0}^{m} {b}_{j} \cdot {c}_{j} \\ = {\sum }_{j = 0}^{m - 1} \frac{{CW}_{j} - 1}{2} {p}^{j} ( 1 - p ) + \frac{{CW}_{max} - 1}{2} {p}^{m} \\ = \frac{{CW}_{min}}{2 ( 1 - 2 p )} [ 1 - p - {p ( 2 p )}^{m} ] - \frac{1}{2}\end{matrix}$$

Thus, the average contention window size L depends on the average collision ratio p, and average channel attempt rate λ, given CWⱼ=2^{j}·CWₘᵢₙ and CWₘₐₓ=2^{m}·CWₘᵢₙ.

Thus, using L⁽⁰⁾, which represents the largest back-off window size, first estimates for the values of λ⁽⁰⁾ and p⁽⁰⁾ may be made using the equations for λ and p above. Then, by applying the equation for calculating L above, a refined estimate L⁽¹⁾ of the average contention window size may be computed, from which second estimates of λ⁽¹⁾ and p⁽¹⁾ may be made. The iteration is repeated until the difference between two consecutive estimates for the average contention size is less than a predetermined value, i.e., |L^{(j+1)}−L^{(j)}|<ε, where ε denotes a pre-defined small value. The estimates at that time for the average channel attempt rate λ and the channel collision rate p are adopted.

In the following discussion, the average time used for ATIM message transmission is denoted T_{A}, the number of successful transmissions achieved within T_{A} is denoted N_{f-suc}, and the average number of STAs that is a party for a successful ATIM/ACK exchange within T_{A} is denoted N_{n-suc}. These STAs remains in an awake state during the data transmission period of the beacon interval. Note that N_{f-suc} is no less than N_{n-suc} because each STA may transmit more than one ATIM/ACK message.

The probability of collision p_{f}, given at least one ATIM transmission, is

$$\begin{matrix}{p}_{f} = P [ collision \text{\vert} there is transmission ] \\ = \frac{P [ collision ]}{P [ there is transmission ]} \\ = \frac{1 - {ⅇ}^{- λ} - λ {ⅇ}^{- λ}}{1 - {ⅇ}^{- λ}}\end{matrix}$$

Therefore, the probability of a successful ATIM transmission pₛ is

$${p}_{s} = 1 - {p}_{f} = \frac{λ {ⅇ}^{- λ}}{1 - {ⅇ}^{- λ}} ,$$

and the probability that a successful transmission at the kth attempt is pₖ=pₛ(1−pₛ)^{k-1}. Therefore, the expected number of attempts before a successful ATIM transmission is achieved is

$${n}_{1 st} = 1 / {p}_{s} = \frac{1 - {ⅇ}^{- λ}}{λ {ⅇ}^{- λ}} .$$

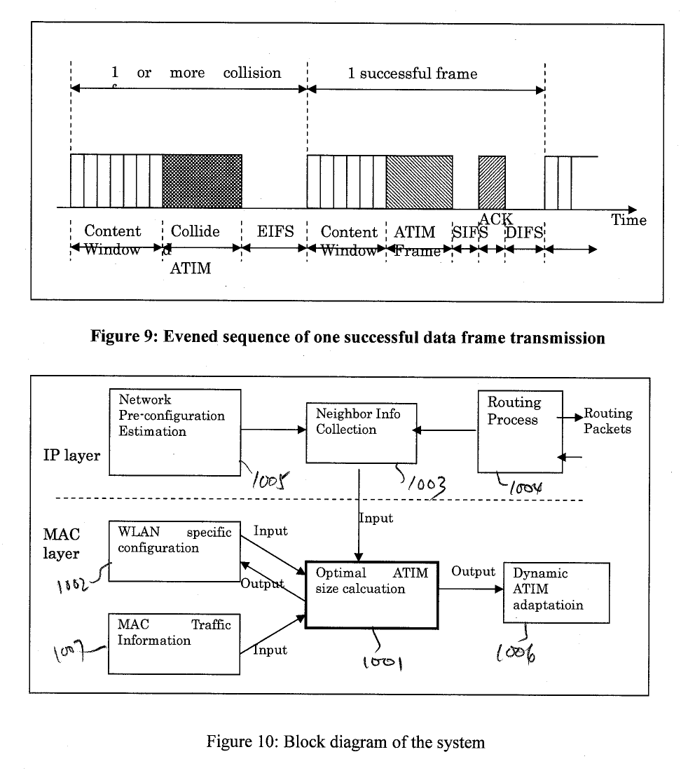

FIG. 9 shows, with respect to transmission of an ATIM frame, the sequences of events that occur when a collision occurs and when a successful exchange of ATIM/ACK messages is achieved, respectively. As shown in FIG. 9, following a contention window, if a collision occurs, an EIFS interval follows the detection of the collision. Conversely, if ATIM message is successfully transmitted, an ACK message is returned from the recipient of the ATIM message after a SIFS interval. The ACK message is followed by another SIFS interval, followed by a DIFS interval. Hence, the expected time to complete a successful transmission, tₜₒₜₐₗ₋ₒₙₑ, is given by:

$$\begin{matrix}{t}_{total - one} = ( {n}_{1 st} - 1 ) \cdot {t}_{fail - one} + {t}_{suc - one} \\ = ( {n}_{1 st} - 1 ) \cdot ( {t}_{wait} + {t}_{ATIM} + EIFS ) + \\ ( {t}_{wait} + {t}_{ATIM} + SIFS + {t}_{ACK} + SIFS + DIFS ) \\ = {n}_{1 st} ( {t}_{wait} + {t}_{ATIM} ) + ( {n}_{1 st} - 1 ) \cdot \\ EIFS + 2 SIFS + {t}_{ACK} + DIFS \\ = \frac{1 - {ⅇ}^{- λ}}{λ {ⅇ}^{- λ}} ( \frac{1}{λ} + {t}_{ATIM} ) + \frac{1 - {ⅇ}^{- λ} - λ {ⅇ}^{- λ}}{λ {ⅇ}^{- λ}} \cdot \\ EIFS + 2 SIFS + {t}_{ACK} + DIFS\end{matrix}$$

where EIFS, SIFS, and DIFS are predefined system parameters, t_{fail-one} and t_{suc-one} are the times for a collision and a successful transmission, respectively, t_{wait} is the contention window, and t_{ATIM} and t_{ACK} are the required times to transmit an ATIM frame and a ACK frame, respectively. Let F_{ATIM} be the total length of a data frame, F_{ACK} be the total length of an ACK frame, and Rₜᵣₐₙₛ be the channel transmission rate:

$$\{ \begin{matrix}{t}_{ATIM} = {F}_{ATIM} / {R}_{trans} \\ {t}_{ACK} = {F}_{ACK} / {R}_{trans} .\end{matrix}$$

Hence, within T_{A}, the average number of successful transmissions N_{f-suc}, is given by N_{f-suc}=T_{A}/tₜₒₜₐₗ₋ₒₙₑ. Some nodes may transmit more than one ATIM message. The number of individual nodes N_{n-suc} that successfully send out ATIM/ACK messages is next derived.

An ATIM message indicates that the sender intends to send a data frame during the data transmission period of a beacon interval. The recipient of the ATIM message returns an acknowledgement to the ATIM message in the ATIM window. The recipient of the ATIM message may or may not have a data frame to send to the sender of the ATIM message during the same data transmission period (i.e., a recipient of an ATIM message may send a data frame to the sender of the ATIM message, without itself separately successfully sending an ATIM message to the sender). Hence, there are two possibilities: first, only the sender of a successful ATIM exchange sends a data frame during the data transmission period; second, both the sender and the recipient of a successful ATIM message send data frames during the data transmission period. All of the N_{f-suc} frames are equally likely to be between any two nodes.

Therefore, for each node i, an identically distributed random variable Xᵢ takes on the following values:

$${X}_{i} = \{ \begin{matrix}0 & node i is not among {N}_{f - suc} flows \\ 1 & node i is among {N}_{f - suc} flows\end{matrix}$$

Then E[Xᵢ] is the probability that node i is included by one or more of the N_{f-suc} flows. N is the total number of nodes in the system. Then, the expected number of individual nodes included in the N_{f-suc} flows is given by: N_{n-suc}=E[X₁+X₂+ . . . +X_{N}]=N·E[X]. If only the sender of an ATIM message sends a data frame,

$$E [ X ] = [ 1 - {( \frac{N - 1}{N} )}^{{N}_{f - suc}} ]$$

and

$${N}_{n - suc} = N [ 1 - {( \frac{N - 1}{N} )}^{{N}_{f - suc}} ] .$$

However, if both the sender of an ATIM message and the recipient of the ATIM message send data frames, node i is not included in a flow if it is neither the source nor the recipient of the flow. Hence,

$$\begin{matrix}E [ X ] = [ 1 - {( \frac{N - 1}{N} \cdot \frac{N - 2}{N - 1} )}^{{N}_{f - suc}} ] \\ = [ 1 - {( \frac{N - 2}{N} )}^{{N}_{f - suc}} ] and \\ {N}_{n - suc} = N [ 1 - {( \frac{N - 2}{N} )}^{{N}_{f - suc}} ] .\end{matrix}$$

Following the ATIM window, N_{n-suc} nodes remain in an awake state during the data transmission period and compete to send out data frames. Assuming that every node always has a packet to send, the optimal length of data transmission period is the time needed for every node to successfully transmit at least one packet. If Yᵢ is the time needed for the ith node to successfully transmit its first packet, the total time needed for all N_{n-suc} nodes to finish transmission is: T_{D}=E[Y₁+Y₂+ . . . Y_{n-suc}]=E[Y₁]+E[Y₂]+ . . . E[Y_{n-suc}]. The probability for the ith node to be able to send out a data frame in a slot, given that (i−1) nodes have already transmitted a data frame, is given by:

$$Pr [ ith node transmits a frame ] = \frac{{N}_{n - suc} - ( i - 1 )}{{N}_{n - suc}} .$$

Because the required time is geometrically distributed,

$$E [ {Y}_{i} ] = \frac{1}{Pr [ ith node transmits a frame ]} = \frac{{N}_{n - suc}}{{N}_{n - suc} - ( i - 1 )} .$$

Therefore, the total time for transmitting N_{n-suc} frames is given by:

$$\begin{matrix}{T}_{D} = E [ {Y}_{1} ] + E [ {Y}_{2} ] + … E [ {Y}_{n - suc} ] \\ = \frac{{N}_{n - suc}}{{N}_{n - suc}} + \frac{{N}_{n - suc}}{{N}_{n - suc} - 1} + … + \frac{{N}_{n - suc}}{{N}_{n - suc} - ( {N}_{n - suc} - 1 )} \\ = {N}_{n - suc} \cdot ( 1 + \frac{1}{2} + \frac{1}{3} + … + \frac{1}{{N}_{n - suc}} ) \\ = {N}_{n - suc} [ ln {N}_{n - suc} + o ( 1 ) ] .\end{matrix}$$

At every TBTT, after the last data frame from the previous beacon interval completes its transmission, every STA in the clique competes to send out a beacon frame. The first STA that successfully sends out the beacon message becomes the beacon station in the current beacon interval. When an STA hears a beacon message, it terminates its own beacon transmission and prepares to send its ATIM messages. The average total beacon transmission time, including collision and final successful transmission, is computed as follows. Before sending a beacon message, each STA sets a back-off window size, which is uniformly distributed between [0, 2·CWₘᵢₙ]. The back-off timer decreases by 1 each idle slot. Once the timer for a STA expires, the STA sends out its beacon message. Because a beacon message is not acknowledged, the STA prepare for sending ATIM messages without regard to whether or not its beacon message is received. A beacon message that is not successfully sent because of a collision or an interference allows another STA to become the beacon station when it sends its beacon message.

Because each STA's initial contention window size is 2·CWₘᵢₙ, the average channel attempt rate for beacon transmission λ_{B} is given by

$${λ}_{B} = \frac{N}{2 {CW}_{min}} ,$$

assuming a Poisson distribution. From an analogous discussion about regarding ATIM window, the interval arrival time is exponentially distributed with an average value of 1/λ_{B}. The probability of collision p_{f-B}, given at least one beacon frame transmission, is

$$\begin{matrix}{p}_{f - B} = P [ collision \text{\vert} there is transmission ] \\ = \frac{P [ collision ]}{P [ there is transmission ]} = \frac{1 - {ⅇ}^{- {λ}_{B}} - {λ}_{B} {ⅇ}^{- {λ}_{B}}}{1 - {ⅇ}^{- {λ}_{B}}} .\end{matrix}$$

Therefore, the probability P_{s-B} of a successful transmission of a beacon frame is

$${p}_{s - B} = 1 - {p}_{f - B} = \frac{{λ}_{B} {ⅇ}^{- {λ}_{B}}}{1 - {ⅇ}^{- {λ}_{B}}} .$$

The probability of a successful transmission at the kth attempt is p_{k-B}=p_{s-B}(1−p_{s-B})^{k-1}, and the expected number of attempts for a successful beacon transmission is

$$\begin{matrix}{n}_{B} = 1 / {p}_{s - B} \\ = \frac{1 - {ⅇ}^{- {λ}_{B}}}{{λ}_{B} {ⅇ}^{- {λ}_{B}}} .\end{matrix}$$

After a contention window, beacon frames are transmitted. If the beacon frame transmission is unsuccessful, the transmission is followed by an EIFS interval. Otherwise, after a successful transmission of a beacon frame, a DIFS interval occurs. Therefore, the total expected time T_{B} to a successful transmission of a beacon is

$$\begin{matrix}{T}_{B} = ( {n}_{B} - 1 ) \cdot {t}_{fail - B} + {t}_{suc - B} \\ = ( {n}_{B} - 1 ) \cdot ( {t}_{wait} + {t}_{beacon} + EIFS ) + ( {t}_{wait} + {t}_{beacon} + DIFS ) \\ = {n}_{B} ( {t}_{wait} + {t}_{beacon} ) + ( {n}_{B} - 1 ) \cdot EIFS + DIFS \\ = \frac{1 - {ⅇ}^{- {λ}_{B}}}{{λ}_{B} {ⅇ}^{- {λ}_{B}}} ( \frac{1}{{λ}_{B}} + {t}_{beacon} ) + \frac{1 - {ⅇ}^{- {λ}_{B}} - {λ}_{B} {ⅇ}^{- {λ}_{B}}}{{λ}_{B} {ⅇ}^{- {λ}_{B}}} \cdot EIFS + DIFS\end{matrix}$$

where EIFS, SIFS, and DIFS are predefined system parameters, t_{fail-B} and t_{suc-B} are the times for a collision and a successful transmission of a beacon frame, respectively, t_{wait} is the contention window, and t_{beacon} is the required times to transmit an beacon. Let F_{beacon} be the total length of a beacon frame, and Rₜᵣₐₙₛ be the channel transmission rate:
t_{beacon}=F_{beacon}/Rₜᵣₐₙₛ

To summarize, in the above description shows the derivations of the average time T_{B} to transmit a beacon, the average number of nodes N_{n-suc} that transmit ATIM/ACK messages within an ATIM exchange period of length T_{A}, and the average time T_{D} of a data transmission period for all N_{n-suc} nodes to each transmit at least one frame. The average time T_{R} for a node to finish a packet transmission across a TBTT time boundary is assumed to be t_{data}/2, where t_{data} is the time required to transmit a data frame. Time t_{data} is given by t_{data}=F_{data}/Rₜᵣₐₙₛ, where F_{data} is the average length of a data frame; accordingly, the average time T_{R} is given by

$${T}_{R} = \frac{{F}_{data}}{2 {R}_{trans}} .$$

Referring back to FIG. 8, the total beacon interval T_{Total} is given by T_{Total}=T_{R}+T_{B}+T_{A}+T_{D} and the optimal ATIM window size A_{ATIM} is T_{ATIM}=T_{R}+T_{B}+T_{A}.

FIG. 10 is a block diagram of an overall system architecture under which a node of the present invention may improve an ATIM window size. As shown in FIG. 10, block 1001 performs an optimal ATIM size calculation based on inputs received from wide area network (WLAN) configuration parameters and from traffic information. One input parameter is the number of neighbors of a node. The number of neighbors may be pre-configured or estimated by a network administrator, if the WLAN network is operated or managed by a specific organization (e.g., blocks 1002 and 1005). Alternatively, the number of neighbors may be collected through routing exchange or dynamic node join/leave process (e.g., blocks 1003, 1007, 1005); in that case, the average number of nodes can be used for the calculation. In addition, system specific parameter values such as SIFS, DISF and EIFS times, contention window sizes, data frame sizes and beacon intervals are specified by the system manager or by the nodes themselves. The traffic variation changes the effective number of nodes competing for the channel because current the analysis above is based on saturated cases. Using these parameter values, an “optimal ATIM size” may be calculated in accordance with the discussion provided above for T_{ATIM}. Such a calculated value may be used directly to set the ATIM window size for the system. If an adaptive ATIM size scheme is also used to modify the ATIM size in real time (block 1006), the output T_{ATIM} value from block 1001 may be used as a starting point of any adaptation schemes.

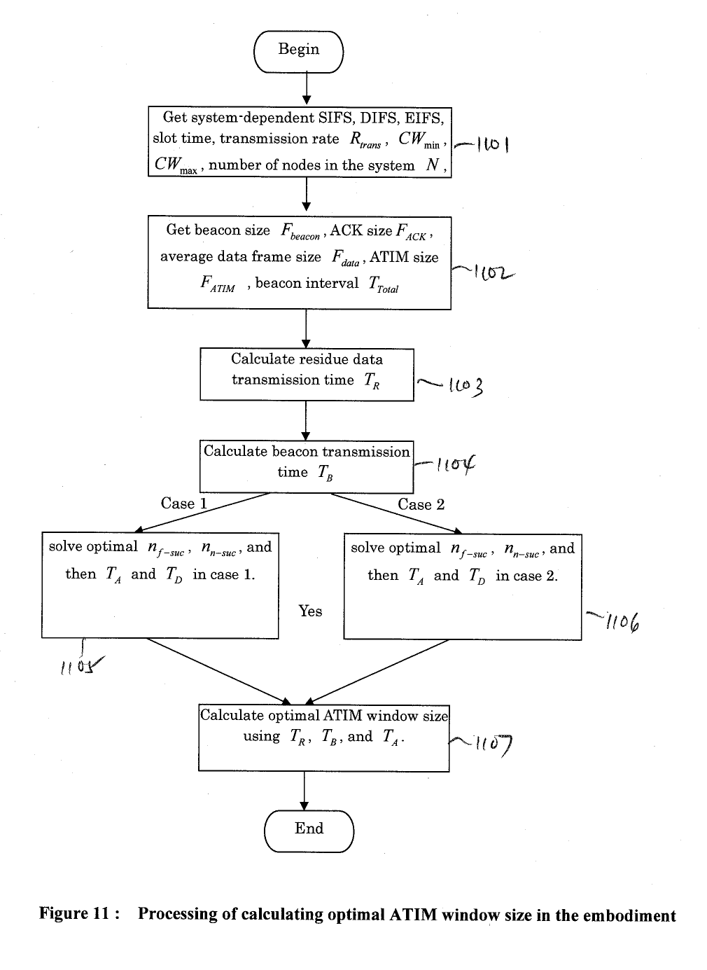

FIG. 11 shows a general procedure to calculate an optimal ATIM window size A_{ATIM}. At step 1101, system dependent parameters, such as SIFS, DIFS, EIFS, channel transmission rate Rₜᵣₐₙₛ, and minimal and maximal contention window size CWₘᵢₙ and CWₘₐₓ are collected. At step 1102, selected parameters are calculated using values adopted by many systems, such as ATIM frame size F_{ATIM}, ACK frame size F_{ACK}, beacon frame size F_{beacon}, average data frame size F_{data}, and beacon interval T_{Total}.

At steps 1103 and 1104, residue data transmission time T_{R} and beacon transmission time T_{B} are calculated. ATIM transmission time T_{A} and data transmission time T_{D} are correlated through the number of nodes N_{n-suc} that successfully transmit ATIM/ACK messages. Steps 1105 and 1106 calculates the total time tₜₒₜₐₗ₋ₒₙₑ to transmit an ATIM message, the average number N_{f-suc} of total frame transmission in T_{A}, the average number of nodes N_{n-suc} from N_{f-suc} respectively for the cases in which only the sender of an ATIM message sends a data frame and the case in which both the sender of the ATIM message and the recipient of the ATIM message send a data frame. The data transmission period T_{D} is calculated from N_{n-suc}. Given a TBTT (Tₜₒₜₐₗ) the values derived for T_{R}, T_{B} and T_{D}, optimal ATIM window T_{A} is calculated. From the values of T_{R}, T_{B}, and T_{A}, the optimal ATIM size T_{ATIM} is calculated.

The above detailed description is provided for illustrating the specific embodiments and is not intended to be limiting. Numerous variations and modifications within the scope of the present invention are possible. The present invention is set forth in the attached claims.

We claim:

1. A method for power saving in an ad hoc wireless computer network, comprising:
determining an effective number of nodes that participate in exchanges of ATIM messages during an ATIM window;
using the effective number of nodes, calculating a length for a data frame transmission window; and
calculating a length for the ATIM window using the calculated data frame transmission window.

2. A method as in claim 1, wherein the effective number of nodes is given by the number of senders of ATIM messages.

3. A method as in claim 1, wherein the effective number of nodes is given by the number of senders and recipients of the ATIM messages.

4. A method as in claim 1, wherein the given time period is a portion of the ATIM window outside of beacon and residue data frame transmissions.

5. A method as in claim 1, wherein the effective number of nodes is derived from a number of successful ATIM message transmissions in a given time period.

6. A method as in claim 1, wherein the number of successful ATIM message transmissions is estimated based on a channel collision rate and a rate of transmission attempt.

7. A method as in claim 6, wherein the channel collision rate and the rate of transmission attempts are derived using an iterative procedure on an average contention window size.

8. A method as in claim 7, wherein an initial value on the average contention window size is a length of a back-off interval.

9. A method as in claim 8, wherein the back-off interval for each node is geometrically distributed.

10. A method as in claim 6, wherein the rate of transmission attempt is exponentially distributed.

11. An mobile node in a wireless mobile computer network, comprising a media access layer that determines an ATIM window size for the wireless mobile network, the ATIM window size being computed using configuration and traffic data from the mobile computer network.

12. A mobile node as in claim 11, further comprising means for dynamically adjusting the ATIM window size based on the determined ATIM window size.

13. A mobile node as in claim 11, wherein the media access layer (a) determines an effective number of nodes that participate in exchanges of ATIM messages during an ATIM window; (b) using the effective number of nodes, calculates a length for a data frame transmission window; and (c) calculates a length for the ATIM window using the calculated data frame transmission window.

14. A mobile node as in claim 13, wherein the effective number of nodes is given by the number of senders of ATIM messages.

15. A mobile node as in claim 13, wherein the effective number of nodes is given by the number of senders and recipients of the ATIM messages.

16. A mobile node as in claim 13, wherein the given time period is a portion of the ATIM window outside of beacon and residue data frame transmissions.

17. A mobile node as in claim 13, wherein the effective number of nodes is derived from a number of successful ATIM message transmissions in a given time period.

18. A mobile node as in claim 13, wherein the number of successful ATIM message transmissions is estimated based on a channel collision rate and a rate of transmission attempt.

19. A mobile node as in claim 18, wherein the channel collision rate and the rate of transmission attempts are derived using an iterative procedure on an average contention window size.

20. A mobile node as in claim 19, wherein an initial value on the average contention window size is a length of a back-off interval.

21. A mobile as in claim 20, wherein the back-off interval for each node is geometrically distributed.

22. A mobile node as in claim 18, wherein the rate of transmission attempt is exponentially distributed.

23. A mobile node as in claim 11, further comprising an internet protocol layer providing information regarding neighboring nodes in the wireless computer network to the media access layer.
